(19) United States
(12) Patent Application Publication
(10) Pub. No.: US 2013/0064164 A1
(43) Pub. Date: Mar. 14, 2013

(54) METHOD AND APPARATUS FOR MANAGING MULTICAST SERVICE

(71) Applicants: Eunkyung KIM, Daejeon (KR); Sung Cheol CHANG, Daejeon (KR); Sung Kyung KIM, Daejeon (KR); Won-lk KIM, Daejeon (KR); Mi Young YUN, Daejeon (KR); Seokki KIM, Gyeonggi-do (KR); Hyun LEE, Daejeon (KR); Chul Sik YOON, Seoul (KR); Kwang Jae LIM, Daejeon (KR)

(72) Inventors: Eunkyung KIM, Daejeon (KR); Sung Cheol CHANG, Daejeon (KR); Sung Kyung KIM, Daejeon (KR); Won-lk KIM, Daejeon (KR); Mi Young YUN, Daejeon (KR); Seokki KIM, Gyeonggi-do (KR); Hyun LEE, Daejeon (KR); Chul Sik YOON, Seoul (KR); Kwang Jae LIM, Daejeon (KR)

(73) Assignee: ELECTRONICS AND TELECOMMUNICATIONS RESEARCH INSTITUTE, Daejeon (KR)

(21) Appl. No.: 13/606,750

(22) Filed: Sep. 7, 2012

(30) Foreign Application Priority Data
Sep. 9, 2011 (KR) 10-2011-0091760
Oct. 31, 2011 (KR) 10-2011-0112480
Nov. 3, 2011 (KR) 10-2011-0113915
Jan. 9, 2012 (KR) 10-2012-0002616
Mar. 6, 2012 (KR) 10-2012-0022940
Sep. 7, 2012 (KR) 10-2012-0099144

(51) Int. Cl. H04W 4/06

(52) U.S. Cl. 370/312

(57) ABSTRACT

A method of managing a multicast service is provided to a mobile station. The mobile station receives from a base station a message including information on a multicast indication cycle including a multicast available interval and a multicast unavailable interval. The mobile station receives a multicast indicator in the multicast available interval of the multicast indication cycle, and receives a multicast traffic at a transmission time indicated by the multicast indicator.

### CROSS-REFERENCE TO RELATED APPLICATION

This application claims priority to and the benefit of Korean Patent Application Nos. 10-2011-0091760, 10-2011-0112480, 10-2011-0113915, 10-2012-0002616, 10-2012-0022940, and 10-201 2-00991 44 filed in the Korean Intellectual Property Office on Sep. 9, 2011, Oct. 31, 2011, Nov. 3, 2011, Jan. 9, 2012, Mar. 6, 2012, and Sep. 7, 2012, respectively, the entire contents of which are incorporated herein by reference.

### BACKGROUND OF THE INVENTION

(a) Field of the Invention

The present invention generally relates a multicast service managing method and apparatus.

(b) Description of the Related Art

A multicast service is used to a group communication where users join in a conversation. In the group communication, the same downlink traffic is simultaneously transmitted to all the users in a group for performing the group communication. Therefore, the users joining the group communication use a multicast connection to transmit data of the group communication.

Even if a mobile station receiving a multicast service enters a power saving mode, the multicast service is required to be seamlessly provided. In a general communication service, the power saving mode is independently applied to each mobile station. However, in the multicast service, the power saving mode is required to be simultaneously applied to all users within a multicast group.

### SUMMARY OF THE INVENTION

Embodiments of the present invention provide a multicast service managing method and apparatus for supporting a power saving mode in a multicast service.

According to an embodiment of the present invention, a method of managing a multicast service is provided by a mobile station. The method includes receiving a message including information on a multicast indication cycle from a base station, the multicast indication cycle including a multicast available interval and a multicast unavailable interval, receiving a multicast indicator in the multicast available interval of the multicast indication cycle, and receiving a multicast traffic at a transmission time indicated by the multicast indicator.

The multicast indicator may include a multicast group identifier in which the multicast traffic is transmitted and a transmission time of the multicast traffic.

A plurality of multicast groups may be divided into a plurality of subgroups, and the multicast indicator may include a multicast group indicator and a multicast traffic indicator. In this case, the multicast group indicator may include information on a subgroup in which there is a multicast traffic to be transmitted and a transmission time of the multicast traffic indicator. The multicast traffic indicator may include information on a multicast group identifier in which there is a multicast traffic to be transmitted and a transmission time of the multicast traffic.

The information on the subgroup may be represented as a bitmap. In this case, a plurality of bits of the bitmap may correspond to the plurality of subgroups, respectively. When the value of each bit of the bitmap is any one of 0 and 1, there may be a multicast traffic for at least one multicast group of a subgroup corresponding to said bit. When the value of each bit of the bitmap is the other one of 0 and 1, there may be no multicast traffic for any multicast groups of a subgroup corresponding to said bit.

Each bit of the bitmap may indicate predetermined most significant bits of the multicast group identifier. A number of predetermined most significant bits may be a number of the subgroups.

The information on the multicast group identifier may be represented as a bitmap. In this case, a plurality of bits of the bitmap may correspond to the plurality of multicast groups included in a corresponding subgroup, respectively. When the value of each bit of the bitmap is any one of 0 and 1, there may be a multicast traffic for a multicast group corresponding to said bit. When the value of each bit of the bitmap is the other one of 0 and 1, there may be no multicast traffic for a multicast group corresponding to said bit.

Each bit of the bitmap may indicate predetermined least significant bits of the multicast group identifier. A number of predetermined least significant bits may be a number of the multicast group included in the corresponding subgroup.

The information on the multicast indication cycle may include predetermined least significant bits of a frame number or a superframe number indicating a start of the multicast indication cycle.

The multicast available interval may correspond to the first frame or the first superframe of the multicast indication cycle.

According to another embodiment of the present invention, a method of managing a multicast service is provided by a base station. The method includes transmitting a message including information on a multicast indication cycle to a mobile station, the multicast indication cycle including a multicast available interval and a multicast unavailable interval, transmitting a multicast indicator in the multicast available interval of the multicast indication cycle, and transmitting a multicast traffic at a transmission time indicated by the multicast indicator.

The multicast indicator may include a multicast group identifier in which the multicast traffic is transmitted and a transmission time of the multicast traffic.

A plurality of multicast groups may be divided into a plurality of subgroups, and the multicast indicator may include a multicast group indicator and a multicast traffic indicator. In this case, the multicast group indicator may include information on a subgroup in which there is a multicast traffic to be transmitted and a transmission time of the multicast traffic indicator. The multicast traffic indicator may include information on a multicast group identifier in which there is a multicast traffic to be transmitted and a transmission time of the multicast traffic.

The information on the subgroup may be represented as a bitmap. In this case, a plurality of bits of the bitmap may correspond to the plurality of subgroups, respectively. When the value of each bit of the bitmap is any one of 0 and 1, there may be a multicast traffic for at least one multicast group of a subgroup corresponding to said bit. When the value of each bit of the bitmap is the other one of 0 and 1, there may be no multicast traffic for any multicast groups of a subgroup corresponding to said bit.

Each bit of the bitmap may indicate predetermined most significant bits of the multicast group identifier. A number of predetermined most significant bits may be a number of the subgroups.

The information on the multicast group identifier may be represented as a bitmap. In this case, a plurality of bits of the bitmap may correspond to the plurality of multicast groups included in a corresponding subgroup, respectively. When the value of each bit of the bitmap is any one of 0 and 1, there may be a multicast traffic for a multicast group corresponding to said bit. When the value of each bit of the bitmap is the other one of 0 and 1, there may be no multicast traffic for a multicast group corresponding to said bit.

Each bit of the bitmap may indicate predetermined least significant bits of the multicast group identifier. A number of predetermined least significant bits may be a number of the multicast group included in the corresponding subgroup.

The information on the multicast indication cycle may include predetermined least significant bits of a frame number or a superframe number indicating a start of the multicast indication cycle.

The multicast available interval may correspond to the first frame or the first superframe of the multicast indication cycle.

According to yet another embodiment of the present invention, an apparatus for managing a multicast service is provided. The apparatus includes a receiver and a controller. The receiver receives from a base station a message including information on a multicast indication cycle including a multicast available interval and a multicast unavailable interval, receives a multicast indicator in the multicast available interval of the multicast indication cycle, and receives a multicast traffic at a transmission time indicated by the multicast indicator. The controller identifies the multicast available interval of the multicast indication cycle, and identifies the transmission time indicated by the multicast indicator.

According to yet another embodiment of the present invention, an apparatus for managing a multicast service is provided. The apparatus includes a transmitter and a controller. The transmitter transmits to a mobile station a message including information on a multicast indication cycle including a multicast available interval and a multicast unavailable interval, transmits a multicast indicator in the multicast available interval of the multicast indication cycle, and transmits a multicast traffic at a transmission time indicated by the multicast indicator. The controller generates the multicast indicator including the transmission time.

### BRIEF DESCRIPTION OF THE DRAWINGS

FIG. 1 to FIG. 3 each show a multicast communication system according to an embodiment of the present invention.

FIG. 4 shows a multicast connection establishment method according to an embodiment of the present invention.

FIG. 5 is a flowchart showing a multicast service managing method according to an embodiment of the present invention.

FIG. 6 shows a multicast indication cycle of a multicast service managing method according to an embodiment of the present invention.

FIG. 7 shows a multicast indicator according to an embodiment of the present invention.

FIG. 8 shows a multicast group indicator bitmap of a multicast service managing method according to an embodiment of the present invention.

FIG. 9 to FIG. 13 are flowcharts of a multicast indication cycle transmitting procedure according to various embodiments of the present invention.

FIG. 14 and FIG. 15 each is a block diagram of a multicast service managing apparatus according to an embodiment of the present invention

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “mobile station (MS)” may designate a terminal, a mobile terminal (MT), an advanced mobile station (AMS), a high reliability mobile station (HR-MS), a subscriber station (SS), a portable subscriber station (PSS), an access terminal (AT), a user equipment (UE), and so on, or may include all or some functions thereof.

Further, the term “base station” (BS) may designate an advanced base station (ABS), a high reliability base station (HR-BS), a node B, an evolved node B (eNodeB), an access point (AP), a radio access station (RAS), a base transceiver station (BTS), an MMR (mobile multihop relay)-BS, a relay station (RS) performing base station function, a relay node (RN) performing base station function, an advanced relay station (ARS) performing base station function, a high reliability relay station (HR-RS) performing the base station function, a small cell BS (femto BS, home node B (HNB), pico BS, metro BS, micro BS, and so on), and so on, or may include all or some functions thereof.

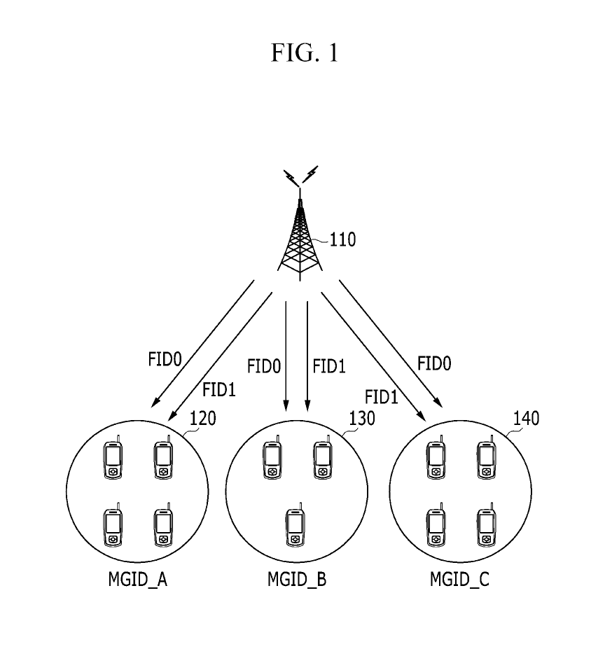

FIG. 1 shows a multicast communication system according to an embodiment of the present invention.

Referring to FIG. 1, a base station 110 uses a multicast group identifier (ID) allocated to a multicast group 120, to provide the multicast group 120 including a plurality of mobile stations with a multicast communication. The multicast group ID is uniquely allocated within the base station 110 and has a finite size. The multicast group ID is used as an ID for notifying the multicast group of the allocated resource. Other multicast groups 120, 130, and 140 have different multicast group ID MGID_A, MGID_B, and MGID_C.

The base station 110 uses a flow identifier (FID) for identifying a connection besides the multicast group ID. The base station 110 allocates the FID in each multicast group ID, thereby uniquely identifying the connection, i.e., a service flow within the multicast group. Since the FID is an ID for identifying a signal or traffic connection within the multicast group, a particular connection of the multicast group can be identified a combination of the multicast group ID and FID in the base station 110. That is, the base station 110 uses the multicast group ID and the FID to provide the multicast group 120 with a multicast service. The same FID (FID0 or FID) may be used in the other multicast groups 120, 130, and 140.

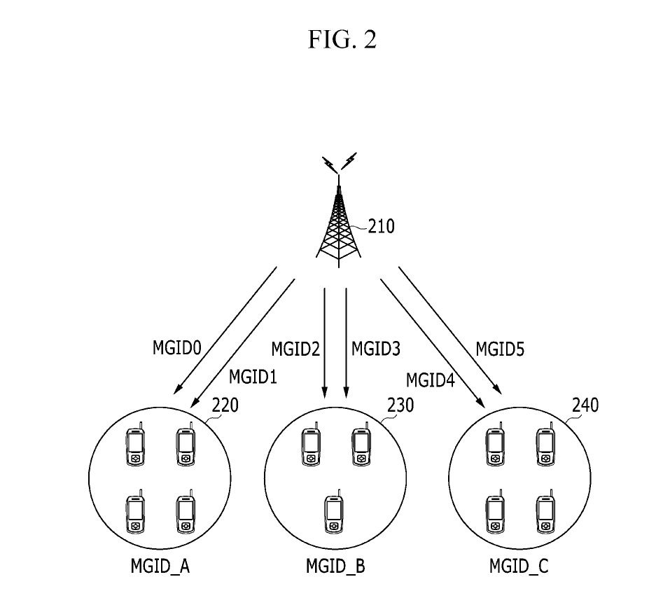

FIG. 2 shows a multicast communication system another embodiment of the present invention.

Referring to FIG. 2, a base station 210 uses a multicast group ID to provide a multicast group 220 including a plurality of mobile stations with the multicast service. The multicast group ID is uniquely allocated for identifying a connection, i.e., a service flow of the multicast group, and has a finite size. This multicast group ID may have a greater size than the multicast group ID described in FIG. 1, in order to identify the service flow as well as the multicast group. For example, the multicast group ID of FIG. 1 may have 12 bits, and the multicast group ID of FIG. 2 may have 16 bits.ID

Other multicast group IDs (MGID0, MGID1, MGID2, MGID3, MGID4, and MGID5) are used in different multicast groups 220, 230, and 240. A multicast resource allocated to the multicast service can be notified to the multicast group through the multicast group ID.

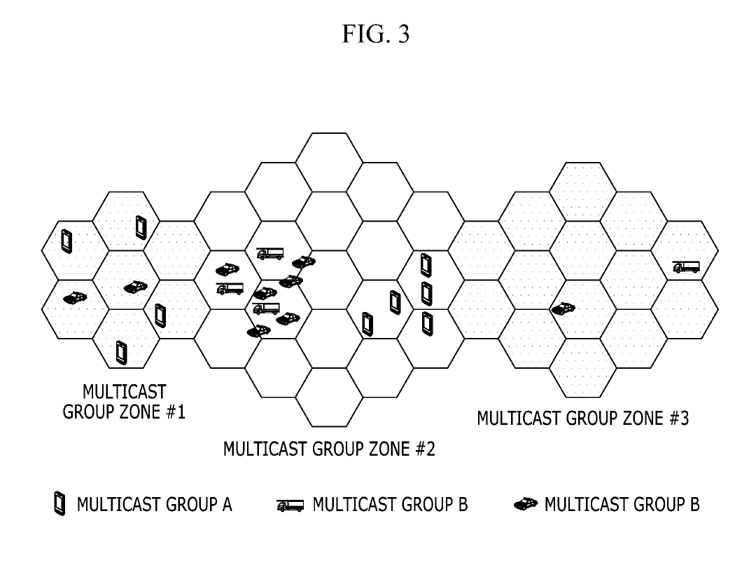

FIG. 3 shows a multicast communication system according to yet another embodiment of the present invention.

Referring to FIG. 3, a multicast group zone is defined as a base station set including at least one base station in a group communication system according to an embodiment of the present invention. A unique multicast group zone ID is allocated to the multicast group zone. A multicast group ID having a unique value is allocated to a multicast group within the multicast group zone, and a multicast service can be identified using an FID within the multicast group. That is, the multicast service that is provided within the multicast group zone can be identified using the multicast group ID and FID. Alternatively, a multicast group ID having a unique value is allocated to a multicast group within the multicast group zone, and a multicast service that is provided within the multicast group zone can be identified using the multicast group ID.

In the multicast group zone, a set of base stations uses the same multicast group ID and FID or the same multicast group ID for transmitting data of a certain service flow. Accordingly, if a mobile station has already registered with a base station for a multicast service, the mobile station can be seamlessly receive the multicast service without reregistering with other base station even if the mobile station moves to the other base station within the same multicast group zone. If the mobile station moves from a base station to another base station, those base stations provide the same multicast service but belong to different multicast group zone, the mobile station can seamlessly receive the multicast service by updating a parameter associated with the multicast service.

If only one base station belongs to a multicast group zone, the single base station uses a multicast group ID for providing a multicast service, independently from other base stations.

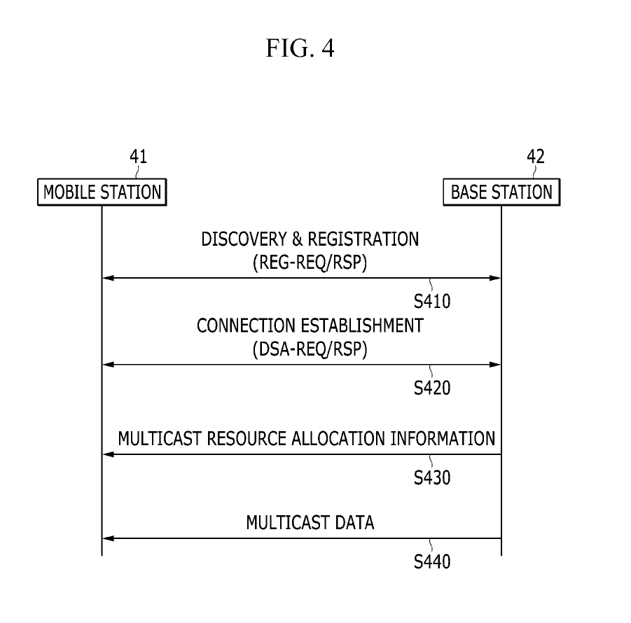

FIG. 4 shows a multicast connection establishment method according to an embodiment of the present invention.

Referring to FIG. 4, a mobile station 41 transmits a registration request (REG-REQ) message and a base station 42 transmits a registration response (REG-RSP) message to the mobile station 41 in response to the REG-REQ message (S410). To discover a multicast service, the mobile station 41 informs the base station 42 of support of multicast transmission by the REG-REQ message and the base station 42 registers the mobile station 41 by the REG-RSP message.

When the mobile station 41 registers to receive the multicast service, either the mobile station 41 or the base station 42 initiates a dynamic service addition (DSA) procedure for a multicast connection service (S420). The one node of the mobile station 41 and the base station 42 transmits a DSA-REQ message to the other node and receives a DSA-RSP message from the other node such that the multicast connection is established.

The DSA-REQ and DSA-RSP messages include a multicast parameter associated with the multicast service. The multicast parameter includes a multicast group ID of a multicast group to which a service flow is added. The multicast parameter may further include a FID associated with the multicast group ID.

Further, when a multicast group zone is supported, the multicast parameter may further include a multicast group zone ID where the service flow is valid. The mobile station 41 can add the service flow for starting a multicast service by the multicast parameter. Alternatively, the base station may periodically broadcast a multicast group zone ID through a broadcast message. If the multicast group zones are not locally overlapped with each other and are identified from each other (that is, a base station belongs to only one multicast group zone or the multicast group zone is not defined), the multicast parameter of the DSA-REQ or DSA-RSP message may not include multicast group zone ID.

The mobile station 41 and the base station 42 may not exchange a multicast service capability in the REQ-REQ/RSP exchange procedure (S410) but exchange the multicast service capability in the DSA-REQ/RSP exchange procedure (S420).

As such, after establishing the service flow, the mobile station 41 receives a downlink control channel including multicast resource allocation information from the base station 42 (S430), and receives multicast data from the base station 42 through the allocated resource (S440).

When a change of the service flow is required in the multicast service, the mobile station 41 and the base station 42 may perform a dynamic service change (DSC) procedure. That is, any one node of the mobile station 41 and the base station 42 transmits a DSC-REQ message, and the other node responds as a DSC-RSP message. In this case, the DSC-REQ message and the DSC-RSP message include a multicast parameter. The multicast parameter may include a current multicast group ID and a new multicast group ID, or current multicast group ID and FID and new multicast group ID and FID. The multicast parameter may further include a new multicast group zone ID.

When the multicast service is terminated, the mobile station 41 and the base station 42 may perform a dynamic service delete (DSD) procedure to delete the service flow. In this case, the multicast service of the multicast group may be terminated using the multicast group ID in the DSD procedure. The base station may terminate the multicast service using the multicast group zone ID in the DSD procedure. Any one node of the mobile station 41 and the base station 42 transmits a DSD-REQ message, and the other node responds as a DSD-RSP message.

As described above, according to an embodiment of the present invention, a mobile station and a base station can identify a supported multicast service through an exchange of a multicast service capability, and add, change or delete a service flow for the multicast service through a DSx (DSA, DSC, or DSD) procedure.

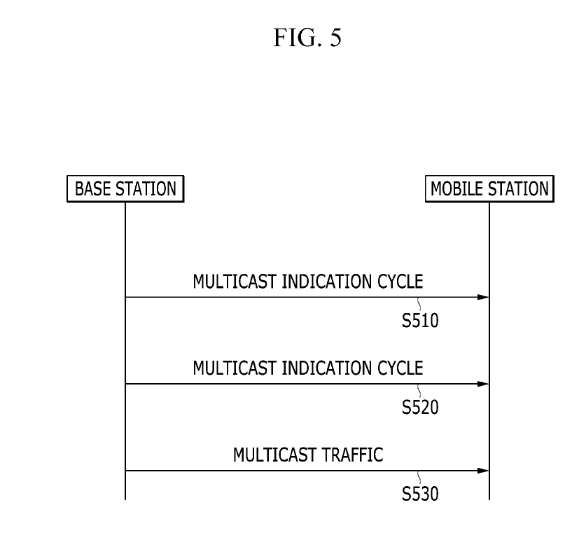

On the other hand, the mobile station receiving the multicast service may enter a power saving mode such as an idle mode or a sleep mode. Operations of the mobile station and the base station are described with reference to FIG. 5 to FIG. 8.

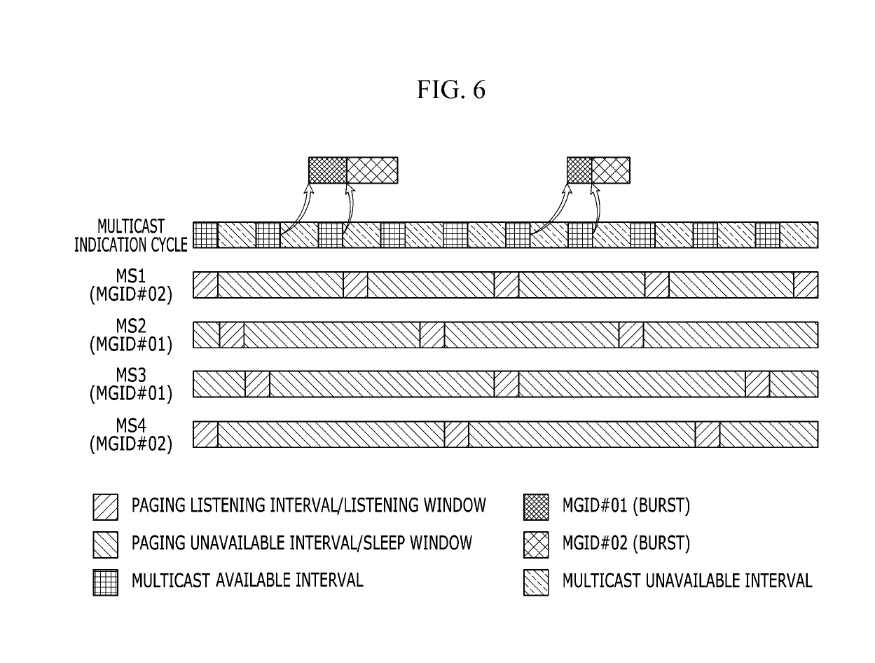

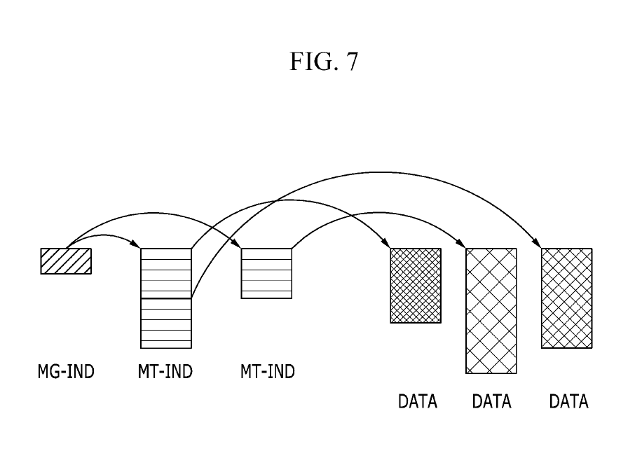

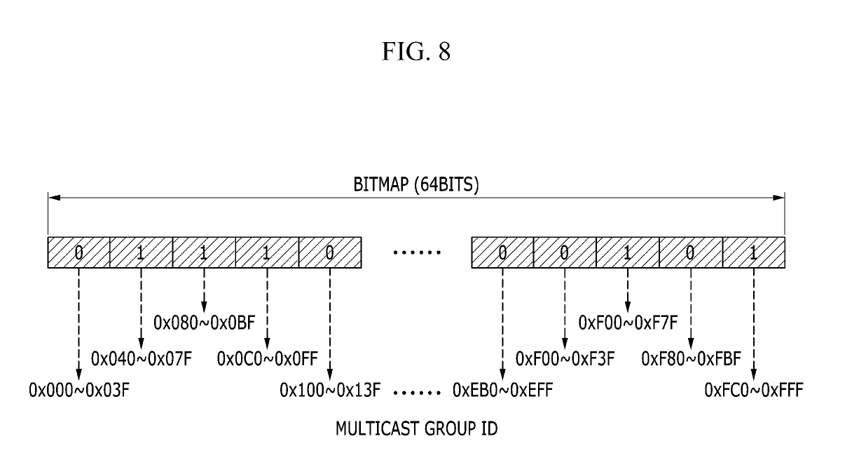

FIG. 5 is a flowchart showing a multicast service managing method according to an embodiment of the present invention, FIG. 6 shows a multicast indication cycle of a multicast service managing method according to an embodiment of the present invention, FIG. 7 shows a multicast indicator according to an embodiment of the present invention, and FIG. 8 shows a multicast group indicator bitmap of a multicast service managing method according to an embodiment of the present invention.

Referring to FIG. 5, a base station transmits information on a multicast indication cycle to a mobile station (S510). The multicast indication cycle information may be transmitted through a control message. The multicast indication cycle is unique to a multicast group zone. As shown in FIG. 6, the multicast indication cycle consists of a multicast available interval and a multicast unavailable interval. The multicast indication cycle of a management cycle for a management before or after a connection establishment may be equal to the multicast indication cycle of a service cycle for a data transmission after the connection establishment. Alternatively, both the multicast indication cycles may be independently operated. When they are independently operated, the base station may notify this operation when the connection is established.

The multicast available interval is an interval for indicating a connection establishment/change/delete for a multicast service within a multicast indication cycle or for indicating whether to transmit data or not after the connection establishment. A multicast indicator is transmitted in the multicast available interval. When the management cycle and the service cycle are independently operated, different indicators or a single indicator may exist for the cycles. The indicator may be provided through a message, a control channel, or a MAC header. The multicast unavailable interval is an interval for the power saving. The indicator operated in the management cycle or the service cycle is not transmitted in the multicast unavailable interval.

Each of mobile stations MS1, MS2, MS3, and MS4 has a power saving cycle such a paging cycle or sleep cycle in a power saving mode. The power saving cycle has a paging listening interval and a paging unavailable interval. The paging listening interval and the paging unavailable interval may be referred to as a listening window and a sleep window, respectively. An example shown in FIG. 6, the mobile stations MS2 and MS3 belong to a multicast group with a multicast group ID MG ID#01, and the mobile stations MS1 and MS4 belong to a multicast group with a multicast group ID MGID#02. The multicast indication cycle may be operated independently from the power saving cycle.

When providing the mobile station with the multicast indication cycle information, the base station may provide at least two among duration of the multicast indication cycle, the multicast available interval, and the multicast unavailable interval. Alternatively, the base station may provide only the duration of the multicast indication cycle. The multicast available interval may be set as the first some frame(s) or superframe(s) of the multicast indication cycle. For example, the multicast available interval may be the first frame or superframe of the multicast indication cycle. Further, the start of the multicast indication cycle may be provided as some information of a frame number or a superframe number. For example, the start of the multicast indication cycle may be indicated in unit of predetermined least significant bits (LSBs), for example 8 LSBs, of the frame number or the superframe number.

Referring to FIG. 5 again, the base station transmits a multicast indicator to the mobile station in the multicast available interval of the multicast indication cycle (S520), and transmits a multicast traffic at a time indicated by the multicast indicator (S530).

Referring to FIG. 7, the multicast indicator includes a multicast group indicator (MG-IND) and a multicast traffic indicator (MT-IND). The MG-IND indicates whether there is a multicast traffic for a specific multicast group. The MG-IND indicates whether there is the multicast traffic and the multicast traffic transmission point directly. Otherwise, MGIND indicates a transmission of the MT-IND for each subgroup wherein the multicast group is divided into subgroups. The MT-IND indicates a transmission of the multicast traffic. The MG-IND may be transmitted at the beginning of the multicast available interval, and the MT-IND may be transmitted at a time indicated by the MG-IND. In an example shown in FIG. 7, the MG-IND indicates whether the MT-IND should be received or not, and the MT-IND indicates transmission information of the multicast traffic.

When the MG-IND indicates multicast traffic transmission information directly, the MG-IND includes a multicast group ID and a transmission point of the traffic as shown in a table 1 or 2. The transmission pint may an offset of a multicast traffic. The offset of the multicast traffic may be represented as a frame number offset in which the base station transmits the multicast traffic on the basis of a transmission point (e.g., time, frame, etc.), some bits (for example, 4 LSBs) of a frame or superframe number, or a time.

Referring to a table 3 or 4, when the MG-IND does not indicate the multicast traffic transmission information directly, the MG-IND includes information on a multicast group or subgroup in which there is a multicast traffic to be transmitted and a transmission point of the MT-IND. The MG-IND may indicate several MT-INDs as shown in FIG. 7, or may indicate one MT-IND as shown in the table 1 or 2. The transmission point of the MT-IND may an offset of the MT-IND. The offset of the MT-IND may be represented as a frame number offset in which the base station transmits the MT-IND. The frame number offset may represent that the MT-IND is transmitted in n-th frame of a current superframe or that the MT-IND is transmitted in n-th frame from a current frame.

Referring to the table 3, the MT-IND includes information on a multicast group ID and a transmission point of the multicast traffic, in order to indicate that the multicast traffic is transmitted. The transmission point of the multicast traffic may be a frame or time offset of the multicast traffic on the basis of a point (time or frame) when the MT-IND is transmitted. The offset of the multicast traffic may be represented as a frame number offset in which the base station transmits the multicast traffic, or some bits (for example, 4 LSBs) of a frame or superframe number.

In the MG-IND, the information on the multicast group or subgroup may be represented as a bitmap. For example, the MG-IND may include a multicast group indicator bitmap (MGIND bitmap) with M bits. M corresponds to the number of subgroups, and the number of multicast groups included in each subgroup is 2^{ML}/M. ML is a length (length of bit) of the multicast group ID. M may be varied according to the length (ML) of the multicast group ID, and may have any one of 2₀, 2¹, . . . , and 2^{ML-1}. For example, when M is 2^{ML/2}, M may be 64 in the multicast group ID with 12 bits, and 256 in the multicast group ID with 16 bits. A value of M may be included in the MG-IND or another message, or may be predefined. The N-th bit of the MGIND bitmap indicates a subgroup of multicast groups ((2^{ML}×N/M) to (2^{ML}×(N+1)/M−1)). When N is 0, the N-th bit corresponds to a most significant bit (MSB) of the MGIND bitmap. When a value of the N-th bit is 0, there is no multicast traffic for any multicast groups in the corresponding subgroup. When the value of the N-th bit is 1, there is a multicast traffic for at least on multicast group in the corresponding subgroup. The values of the bit may be defined oppositely.

In the MT-IND, the multicast group ID information may be represented as a bitmap. For example, the MT-IND may include a multicast traffic indicator bitmap (MTIND bitmap) with K bits. K corresponds to the number of multicast groups in a subgroup, and is 2^{ML}/M. For example, when M is 2^{ML/2}, K is equal to M. The Q-th bit of the MTIND bitmap corresponds to a multicast group ID in the subgroup. When Q is 0, the Q-th bit corresponds to the MSB of the MTIND bitmap. When a value of the Q-th bit is 0, there is no multicast traffic for the corresponding multicast group. When the value of the Q-th bit is 1, there is a multicast traffic for the corresponding multicast group. The values of bit may be defined oppositely.

The N-th bit of the MGIND bitmap indicates log(M) MSBs of the multicast group ID, and the Q-th bit of the MTIND bitmap indicates log(K) LSBs of the multicast group ID. Therefore, the multicast group ID may be identified by the MGIND bitmap and the MTIND bitmap. For example, when the multicast group ID has 16 bits, the N-th bit of the MGIND bitmap indicates log(M) MSBs, i.e., log256(=8) MSBs, and the Q-th bit of the MTIND bitmap indicates log(K) LSBs, i.e., log256(=8) LSBs. Therefore, the multicast group ID with 16 bits can be indicated.

In an example shown in FIG. 8, multicast group IDs with 12 bits are divided into subgroups by using the MGIND bitmap with 64 bits. As shown in FIG. 8, one bit of the MGIND bitmap corresponds to a subgroup of 64 multicast groups. For example, 0-th bit (MSB) of the MGIND bitmap corresponds to a subgroup of multicast groups with multicast group IDs (0×000 to 0×03F), and corresponds to 6 MSB, i.e., “000000” of the multicast group IDs (0×000 to 0×03F). 63rd bit (the last bit) of the MGIND bitmap corresponds to a subgroup of multicast groups with multicast group IDs (0×FC0 to 0×FFF), and corresponds to 6 MSBs, i.e., “111111” of the multicast group IDs (0×FC0 to 0×FFF). In this case, 6 LSBs of the multicast group IDs in the multicast groups of each subgroup may be indicated by the MTIND bitmap.

Tables 1 and 2 show examples of the MG-IND, and tables 3 and 4 show examples of the MT-IND.

TABLE 1

| | Size | | |
|---|---|---|---|
| Field | (bits) | Value/Description | Condition |
| Indication type | 1 | 0b0: full MGID indication | |
| | | 0b1: MGIND + MTIND indication | |
| If (Indication type == 0b0) { | | | |
| For(i=0; | | Num_MGID is the number of | |
| i<Num_MGID;i++){ | | multicast group to indicate multicast | |
| | | traffic is transmitted. | |
| | | Range: 0~32 | |
| Multicast Group ID | 12 | Length of Multicast Group ID | |
| Action code | 3 | If bit0 = 1, perform network entry or | |
| | | exit sleep mode | |
| | | If bit1 = 1, perform ranging procedure | |
| | | with ranging purpose indication is set | |
| | | to multicast service flow | |
| | | update(=0b1110) If bit2 = 1, | |
| | | receiving multicast traffic | |
| If (action code bit2 == 1) { | | | |
| Offset of multicast traffic | 4 | frame number offset in which the BS | Shall be |
| | | transmits multicast traffic | present |
| } | | | |
| } | | | |
| }Else if(Indication type == | | | |
| 0b1) { | | | |
| MGIND bitmap | M(=64) | Indicates whether a corresponding | |
| | | subgroup of multicast group has | |
| | | multicast data to transmit, where the | |
| | | N-th bit of MGIND bitmap [MSB | |
| | | corresponds to N = 0] corresponds to | |
| | | MGIDs in a subgroup (2^{ML} × N/M to | |
| | | 2^{ML} × (N + 1)/M − 1) | |
| | | 0: There is no multicast traffic for any | |
| | | of multicast groups in the | |
| | | corresponding multicast subgroup | |
| | | 1: There is multicast traffic for at least | |
| | | one multicast group in the | |
| | | corresponding multicast subgroup | |
| Offset of multicast MT-IND | 2 | frame number offset in which the | Shall be |
| message | | ABS transmits MT-IND message | present |
| | | 0b00: first frame of this superframe | |
| | | 0b01: second frame of this | |
| | | superframe | |
| | | 0b10: third frame of this superframe | |
| | | 0b11: fourth frame of this superframe | |
| } | | | |

TABLE 2

| | Size | | |
|---|---|---|---|
| Field | (bits) | Value/Description | Condition |
| Indication type | 1 | 0b0: full MGID indication | |
| | | 0b1: MGIND + MTIND indication | |
| If (Indication type == 0b0) | | | |
| { | | | |
| For(i=0; | | Num_MGID is the number of | |
| i<Num_MGID;i++){ | | multicast group to indicate multicast | |
| | | traffic is transmitted. | |
| Multicast Group ID | 16 | Length of Multicast Group ID | |
| Action code | 3 | If bit0 = 1, perform network entry or | |
| | | exit sleep mode | |
| | | If bit1 = 1, perform ranging procedure | |
| | | with ranging purpose indication is set | |
| | | to multicast service flow update | |
| | | If bit2 = 1, receiving multicast traffic | |
| If (action code bit2 == 1) { | | | |
| Offset of multicast traffic | 4 | frame number offset in which the BS | Shall be |
| | | transmits multicast traffic | present |
| } | | | |
| } | | | |
| }Else if(Indication type == | | | |
| 0b1) { | | | |
| MGIND bitmap | M(=256) | Indicates whether a corresponding | |
| | | subgroup of multicast group has | |
| | | multicast data to transmit, where the | |
| | | N-th bit of MGIND bitmap [MSB | |
| | | corresponds to N = 0] corresponds to | |
| | | MGIDs in a subgroup (2^{ML} × N/M to | |
| | | 2^{ML} × (N + 1)/M − 1) | |
| | | 0: There is no multicast traffic for any | |
| | | of multicast groups in the | |
| | | corresponding multicast subgroup | |
| | | 1: There is multicast traffic for at | |
| | | least one multicast group in the | |
| | | corresponding multicast subgroup | |
| Offset of multicast MT-IND | 2 | frame number offset in which the BS | Shall be |
| message | | transmits MT-IND message | present |
| | | 0b00: [current + 1]th frame | |
| | | 0b01: [current + 2]th frame | |
| | | 0b10: [current + 3]th frame | |
| | | 0b11: [current + 4]th frame | |
| } | | | |

TABLE 3

| | Size | | |
|---|---|---|---|
| Field | (bits) | Value/Description | Condition |
| For (i=0; i<L; i++) { | | L equals the number of bits in | |
| | | MGIND bitmap whose bit is set to 1 | |
| | | and whose offset is the current | |
| | | frame. The bits are ordered by the | |
| | | shortest MSB of MGIND bitmap. | |
| MTIND bitmap | K(=64) | Indicates whether a corresponding | Shall be |
| | | multicast group has multicast data to | present |
| | | transmit, where the Q-th bit of | |
| | | MTIND bitmap [MSB corresponds to | |
| | | Q = 0] corresponds to MGID in the | |
| | | subgroup (Q is the value of logK LSB | |
| | | of multicast group and MSB logM of | |
| | | multicast group is defined by | |
| | | MG-IND message). | |
| | | 0: There is no multicast traffic for the | |
| | | corresponding multicast group | |
| | | 1: There is multicast traffic for the | |
| | | corresponding multicast group | |
| For(j=0;j<P; j++){ | | P equals the number of bits in | |
| | | MTIND bitmap whose bit is set to 1. | |
| Action code | 3 | If bit0 = 1, perform network entry or | |
| | | exit sleep mode | |
| | | If bit1 = 1, perform ranging procedure | |
| | | with ranging purpose indication is set | |
| | | to HR multicast service flow | |
| | | update(=0b1110) | |
| | | If bit2 = 1, receiving multicast traffic | |
| If (action code bit2 == 1){ | | | |
| Offset of multicast traffic | 4 | frame number offset in which the BS | Shall be |
| | | transmits multicast traffic | present |
| } | | | |
| } | | | |
| } | | | |

TABLE 4

| | Size | | |
|---|---|---|---|
| Field | (bits) | Value/Description | Condition |
| For (i=0; i<L; i++) { | | L equals the number of bits in | |
| | | MGIND bitmap whose bit is set to 1 | |
| | | and whose offset is the current | |
| | | frame. The bits are ordered by the | |
| | | shortest MSB of MGIND bitmap. | |
| MTIND bitmap | K(=256) | Indicates whether a corresponding | Shall be |
| | | multicast group has multicast data to | present |
| | | transmit, where the Q-th bit of MTIND | |
| | | bitmap [MSB corresponds to Q = 0] | |
| | | corresponds to MGID in the | |
| | | subgroup (Q is the value of logK LSB | |
| | | of multicast group and MSB logM of | |
| | | multicast group is defined by MG-IND | |
| | | message). | |
| | | 0: There is no multicast traffic for the | |
| | | corresponding multicast group | |
| | | 1: There is multicast traffic for the | |
| | | corresponding multicast group | |
| For(j=0;j<P; j++){ | | P equals the number of bits in MTIND | |
| | | bitmap whose bit is set to 1. | |
| Action code | 3 | If bit0 = 1, perform network entry or | |
| | | exit sleep mode | |
| | | If bit1 = 1, perform ranging procedure | |
| | | with ranging purpose indication is set | |
| | | to HR multicast service flow update | |
| | | If bit2 = 1, receiving multicast traffic | |
| If (action code bit2 == 1){ | | | |
| Offset of multicast traffic | 4 | frame number offset in which the BS | Shall be |
| | | transmits multicast traffic | present |
| } | | | |
| } | | | |
| } | | | |

As described above, according to an embodiment of the present invention, the mobile station determines whether there is the multicast traffic for the multicast group to which it belongs based on the multicast indicator that is received in the multicast available interval of the multicast indication cycle. When there is the multicast traffic, the mobile station can end the power saving mode or receive the multicast traffic at the time indicated by the multicast indicator without ending the power saving mode. Therefore, the power saving mode can be simultaneously supported for all of the mobile stations that belong to the same multicast group. Further, the multicast service managing method according to an embodiment of the present invention can be applicable to a mobile station that has not entered the power saving mode.

When a transmission of the multicast traffic that is persistent during a predetermined interval ends, the mobile station repeats the multicast available interval and the multicast unavailable interval in accordance with the multicast indication cycle. The multicast indicator may indicate a time when the transmission of the multicast traffic ends. Further, the multicast indicator may indicate a transmission time of a next multicast traffic each time the transmission of each multicast traffic ends, and may indicate a time when the transmission of the multicast traffic ends at the transmission time of a previous traffic or indicate, after the multicast traffic is transmitted, that the transmission of the multicast traffic ends.

Furthermore, the multicast indicator may indicate a management such as a connection establishment/delete/change or an update of a multicast parameter. The mobile station can end the power saving mode and perform a ranging or transmit/receive a message, or temporarily end the power saving mode and perform the ranging, in order to update the multicast parameter. The mobile station may notify the base station, by using a ranging request message, that it will perform the ranging to update the multicast parameter. The base station may transmit to the mobile station a ranging response message including the multicast parameter.

As described above, a multicast indication cycle for indicating a data transmission may be included to a multicast indication cycle before a connection establishment such that an operation method depending on the multicast indication cycle may be used.

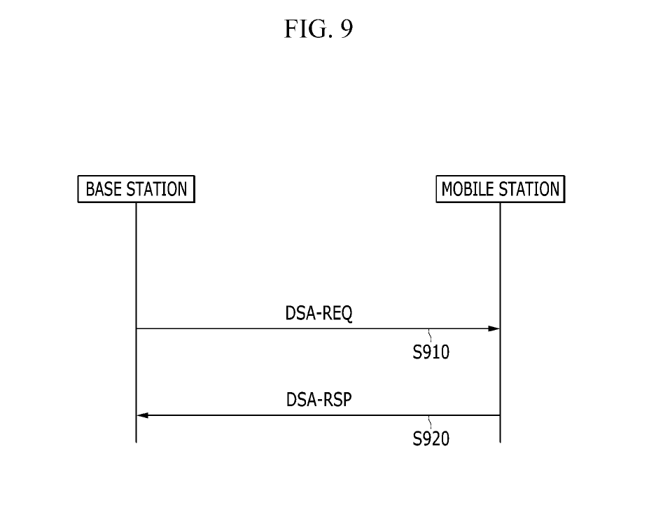

Next, messages for transmitting a multicast indication cycle according to various embodiments of the present invention are described with reference to FIG. 9 to FIG. 13.

FIG. 9 to FIG. 13 are flowcharts of a multicast indication cycle transmitting procedure according to various embodiments of the present invention.

Referring to FIG. 9, when a base station initiates a multicast service, it transmits a DSA-REQ message to a mobile station (S910). The DSA-REQ message includes multicast indication cycle information. The DSA-REQ message may further include a multicast group ID and a multicast group zone ID as a multicast parameter. The mobile station transmits a DSA-RSP message to the base station in response to the DSA-REQ message (S920). Accordingly, the base station can provide the mobile station with the multicast indication cycle before establishing a multicast connection, and establish the multicast connection.

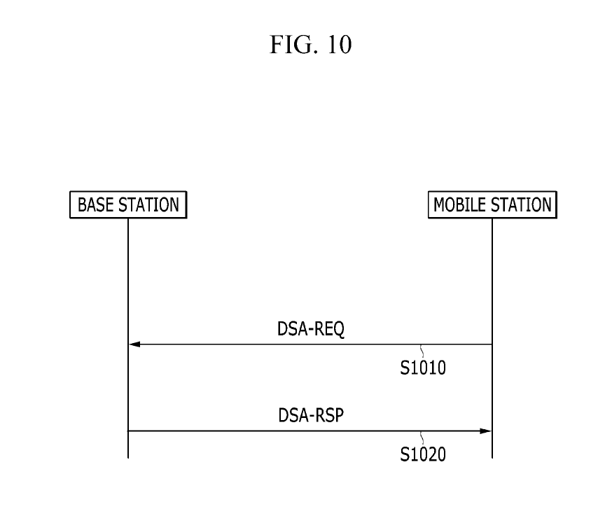

Referring to FIG. 10, when a mobile station initiates a multicast service, it transmits a DSA-REQ message to a base station (S1010). The base station transmits a DSA-RSP message to the mobile station in response to the DSA-REQ message (S1020). The DSA-RSP message includes multicast indication cycle information. The DSA-RSP message may further include a multicast group ID and a multicast group zone ID as a multicast parameter. Accordingly, the base station can provide the mobile station with the multicast indication cycle before establishing a multicast connection, and establish the multicast connection.

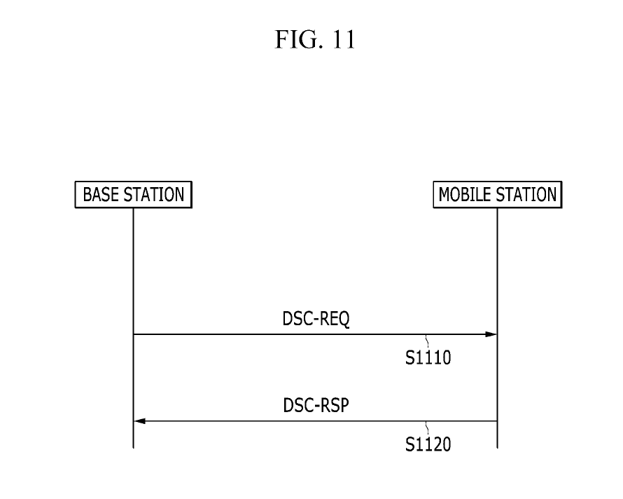

Referring to FIG. 11, for changing a service flow, a base station transmits a DSC-REQ message to a mobile station (S1110). The DSC-REQ message includes multicast indication cycle information to change. The DSC-REQ message may further include a multicast group ID and a multicast group zone ID to change. The mobile station transmits a DSC-RSP message to the base station in response to the DSC-REQ message (S1120). Accordingly, the base station can change the multicast indication cycle together with a service flow while providing the multicast service.

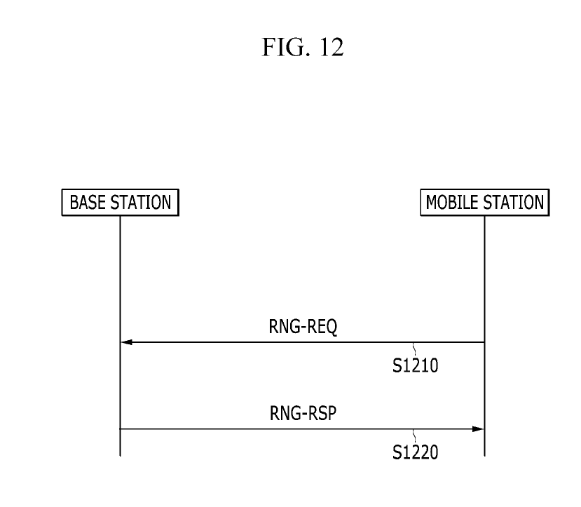

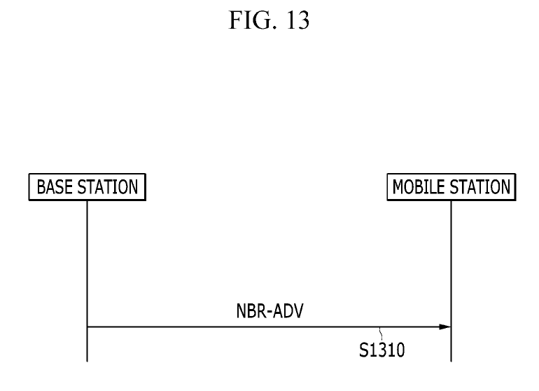

Referring to FIG. 12, when a mobile station of a connected state crosses a boundary of a multicast group zone, the mobile station performs a ranging procedure as a part of the handover with a target base station of the moved cell. The mobile station may update a multicast parameter during the ranging procedure. The mobile station transmits a ranging request (RNG-REQ) message to the base station (S1210). The base station transmits a ranging response (RNG-RSP) message to the mobile station in response to the RNG-REQ message (S1220). Alternatively, when a mobile station of an idle state crosses the boundary of the multicast group zone, the mobile station performs a location update procedure with a base station of the moved cell. The mobile station can update the multicast parameter during the location update procedure. In order to update the location, the mobile station and the base station exchanges the RNG-REQ message and the RNG-RSP message as shown in FIG. 13.

The RNG-RSP message includes multicast indication cycle information. The RNG-RSP message may further include a multicast group ID and a multicast group zone ID for updating the multicast parameter.

Referring to FIG. 13, a base station periodically broadcasts a neighbor advertisement (NBR-ADV) message to support the mobility of mobile station (S1310). The mobile station receives the NBR-ADV message. The NBR-ADV message includes multicast indication cycle information. The NBR-ADV message may further include mapping information between multicast group IDs and FIDS of a current multicast group zone and a neighbor multicast group zone, for supporting the mobility.

Alternatively, the multicast indication cycle may be transmitted through another broadcast message. The broadcast message, for example, is a system configuration descriptor (SCD) message or a downlink channel descriptor (DCD) message.

When the broadcast message such as the NBR-ADV message, the SCD message, or the DCD message includes the multicast indication cycle information, a message such as the DSA message or the DSC message may not include the multicast indication cycle information.

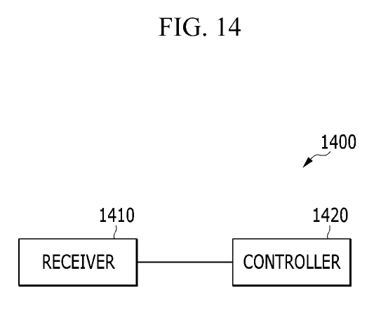

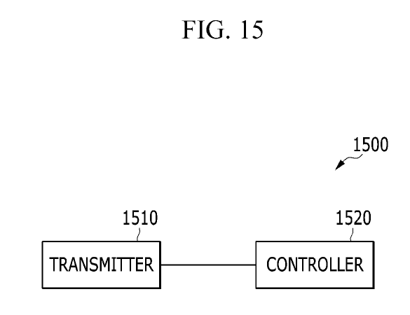

Next, a multicast service managing apparatus for performing a multicast service managing method according to an embodiment of the present invention will be described with reference to FIG. 14 and FIG. 15.

FIG. 14 and FIG. 15 each is a block diagram of a multicast service managing apparatus according to an embodiment of the present invention

Referring to FIG. 14, a multicast service managing apparatus 1400 includes a receiver 1410 and a controller 1420. The multicast service managing apparatus 1400 shown in FIG. 14 may be included to a mobile station or may be the mobile station.

The receiver 1410 receives a message including multicast indication cycle information from a base station, receives a multicast indicator in a multicast available interval of a multicast indication cycle, and receives a multicast traffic at a transmission time indicated by the multicast indicator. The controller 1420 identifies the multicast available interval of multicast indication cycle based on the multicast indication cycle information, and identifies the transmission time indicated by the multicast indicator.

Referring to FIG. 15, a multicast service managing apparatus 1500 includes a transmitter 1510 and a controller 1520. The multicast service managing apparatus 1500 shown in FIG. 15 may be included to a base station or may be the base station.

The transmitter 1510 transmits a message including multicast indication cycle information to a mobile station. The controller 1520 generates a multicast indicator including a transmission time of a multicast traffic. The transmitter 1510 transmits the multicast indicator in a multicast available interval of a multicast indication cycle, and transmits the multicast traffic at the transmission time indicated by the multicast indicator.

At least some functions of a multicast service managing apparatus and method according to an embodiment of the present invention may be configured by hardware or software combined with the hardware. For example, a processor configured by a central processing unit (CPU), a chipset, or a microprocessor, etc. may perform a function of a controller 1420 or 1520. A physical memory may store multicast indication cycle information, a multicast indicator, a multicast traffic, and messages. Further, a transceiver may perform a receiver 1410 or a transmitter 1510.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of managing a multicast service by a mobile station, the method comprising:
receiving a message including information on a multicast indication cycle from a base station, the multicast indication cycle including a multicast available interval and a multicast unavailable interval;
receiving a multicast indicator in the multicast available interval of the multicast indication cycle; and
receiving a multicast traffic at a transmission time indicated by the multicast indicator.

2. The method of claim 1, wherein the multicast indicator includes a multicast group identifier in which the multicast traffic is transmitted and a transmission time of the multicast traffic.

3. The method of claim 1, wherein a plurality of multicast groups are divided into a plurality of subgroups,
the multicast indicator includes a multicast group indicator and a multicast traffic indicator,
the multicast group indicator includes information on a subgroup in which there is a multicast traffic to be transmitted and a transmission time of the multicast traffic indicator, and
the multicast traffic indicator includes information on a multicast group identifier in which there is a multicast traffic to be transmitted and a transmission time of the multicast traffic.

4. The method of claim 3, wherein the information on the subgroup is represented as a bitmap,
a plurality of bits of the bitmap correspond to the plurality of subgroups, respectively,
when a value of each bit of the bitmap is any one of 0 and 1, there is a multicast traffic for at least one multicast group of a subgroup corresponding to said bit, and
when a value of each bit of the bitmap is the other one of 0 and 1, there is no multicast traffic for any multicast groups of a subgroup corresponding to said bit.

5. The method of claim 4, wherein each bit of the bitmap indicates predetermined most significant bits of the multicast group identifier, and
a number of predetermined most significant bits is a number of the subgroups.

6. The method of claim 3, wherein the information on the multicast group identifier is represented as a bitmap,
a plurality of bits of the bitmap correspond to the plurality of multicast groups included in a corresponding subgroup, respectively,
when a value of each bit of the bitmap is any one of 0 and 1, there is a multicast traffic for a multicast group corresponding to said bit, and
when a value of each bit of the bitmap is the other one of 0 and 1, there is no multicast traffic for a multicast group corresponding to said bit.

7. The method of claim 6, wherein each bit of the bitmap indicates predetermined least significant bits of the multicast group identifier, and
a number of predetermined least significant bits is a number of the multicast group included in the corresponding subgroup.

8. The method of claim 1, wherein the information on the multicast indication cycle includes predetermined least significant bits of a frame number or a superframe number indicating a start of the multicast indication cycle.

9. The method of claim 1, wherein the multicast available interval corresponds to the first frame or the first superframe of the multicast indication cycle.

10. A method of managing a multicast service by a base station, the method comprising:
transmitting a message including information on a multicast indication cycle to a mobile station, the multicast indication cycle including a multicast available interval and a multicast unavailable interval;
transmitting a multicast indicator in the multicast available interval of the multicast indication cycle; and
transmitting a multicast traffic at a transmission time indicated by the multicast indicator.

11. The method of claim 10, wherein the multicast indicator includes a multicast group identifier in which the multicast traffic is transmitted and a transmission time of the multicast traffic.

12. The method of claim 10, wherein a plurality of multicast groups are divided into a plurality of subgroups,
the multicast indicator includes a multicast group indicator and a multicast traffic indicator,
the multicast group indicator includes information on a subgroup in which there is a multicast traffic to be transmitted and a transmission time of the multicast traffic indicator, and
the multicast traffic indicator includes information on a multicast group identifier in which there is a multicast traffic to be transmitted and a transmission time of the multicast traffic.

13. The method of claim 12, wherein the information on the subgroup is represented as a bitmap,
a plurality of bits of the bitmap correspond to the plurality of subgroups, respectively,
when a value of each bit of the bitmap is any one of 0 and 1, there is a multicast traffic for at least one multicast group of a subgroup corresponding to said bit, and
when a value of each bit of the bitmap is the other one of 0 and 1, there is no multicast traffic for any multicast groups of a subgroup corresponding to said bit.

14. The method of claim 13, wherein each bit of the bitmap indicates predetermined most significant bits of the multicast group identifier, and
a number of predetermined most significant bits is a number of the subgroups.

15. The method of claim 12, wherein the information on the multicast group identifier is represented as a bitmap,
a plurality of bits of the bitmap correspond to the plurality of multicast groups included in a corresponding subgroup, respectively,
when each bit of the bitmap has any one of 0 and 1, there is a multicast traffic for a multicast group corresponding to said bit, and
when each bit of the bitmap has the other one of 0 and 1, there is no multicast traffic for a multicast group corresponding to said bit.

16. The method of claim 15, wherein each bit of the bitmap indicates predetermined least significant bits of the multicast group identifier, and
a number of predetermined least significant bits is a number of the multicast group included in the corresponding subgroup.

17. The method of claim 10, wherein the information on the multicast indication cycle includes predetermined least significant bits of a frame number or a superframe number indicating a start of the multicast indication cycle.

18. The method of claim 10, wherein the multicast available interval corresponds to the first frame or the first superframe of the multicast indication cycle.

19. An apparatus for managing a multicast service, the apparatus comprising:
a receiver configured to receive a message including information on a multicast indication cycle from a base station, the multicast indication cycle including a multicast available interval and a multicast unavailable interval, to receive a multicast indicator in the multicast available interval of the multicast indication cycle, and to receive a multicast traffic at a transmission time indicated by the multicast indicator; and
a controller configured to identify the multicast available interval of the multicast indication cycle, and to identify the transmission time indicated by the multicast indicator.

20. An apparatus for managing a multicast service, the apparatus comprising:
a transmitter configured to transmit a message including information on a multicast indication cycle to a mobile station, the multicast indication cycle including a multicast available interval and a multicast unavailable interval, to transmit a multicast indicator in the multicast available interval of the multicast indication cycle, and to transmit a multicast traffic at a transmission time indicated by the multicast indicator; and
a controller configured to generate the multicast indicator including the transmission time.
